(19) United States
(12) Patent Application Publication
(10) Pub. No.: US 2010/0225785 A1
(43) Pub. Date: Sep. 9, 2010

(54) IMAGE PROCESSOR AND RECORDING MEDIUM

(75) Inventors: Hiroshi SHIMIZU, Tokyo (JP); Jun Muraki, Tokyo (JP); Hiroyuki Hoshino, Tokyo (JP); Erina Ichikawa, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/718,003

(22) Filed: Mar. 5, 2010

(30) Foreign Application Priority Data
Mar. 5, 2009 (JP) 2009-051876

(51) Int. Cl. H04N 5/76; H04N 9/68

(52) U.S. Cl. 348/231.99; 348/234; 348/E05.031; 348/E09.053

(57) ABSTRACT

A camera device 100 comprises a recording medium 9, an operator input unit 12, and an image synthesis unit 8g. The recording medium 9 stores a plurality of images and a like number of sets of image capturing conditions in associated relationship. The operator input unit 12 issues a command to read a plurality of images from the recording medium 9 and to synthesize the images. The image synthesis unit 8g reads, from the recording medium 9, a plurality of sets of image capturing conditions each associated with a respective one of the images, the command for synthesis of which is issued by the operator input unit 12, processes the remaining one(s) of the plurality of images excluding a particular one image so as to fit the one image in image capturing conditions, and then synthesizes a resulting processed image(s) with the one image.

### CROSS-REFERENCE TO RELATED APPLICATIONS

This application is based on Japanese Patent Application No. 2009-051876 filed on Mar. 5, 2009 and including specification, claims, drawings and summary. The disclosure of the above Japanese patent applications is incorporated herein by reference in its entirety.

### BACKGROUND OF THE INVENTION

1. Field of the Invention

The present invention relates to image processors and recording mediums which synthesizes a plurality of images to produce a synthesized image.

2. Description of the Related Art

Conventionally, there are known techniques for producing a synthesized picture from an image of a subject and an image of a background or a frame picture. For example, JP 2004-159158 discloses a photograph printing device which synthesizes a video and a frame image which are captured by the camera. United States Patent Application 20050225555 discloses Graphic image rendering apparatus in which images are synthesized in such a manner that they look natural.

When a synthesized image is produced from an image of a subject and an image of a background or a frame picture which are different in image capturing conditions, however, there is a possibility that a balance between these images will be inappropriate in the synthesized image. For example, a synthesized image of an image of a subject captured under illumination within a room and an image of a background captured outside in a fine weather would give a sense of discomfort because these images are different in contrast and brightness.

### SUMMARY OF THE INVENTION

It is an object of the present invention to provide an image processor and recording medium which minimizes an influence from the image capturing environment and produces a synthesized image giving little sense of discomfort.

In accordance with an aspect of the present invention, there is provided an image processor comprising: a storage unit configured to store a plurality of images each associated with a respective one of a like number of sets of image capturing conditions set when the plurality of images are captured; a command issuing unit configured to issue a command to synthesize two of the plurality of images stored in the storage unit; an image processing subunit configured to read, from the storage unit, two sets of image capturing conditions each associated with a respective one of the two images the command for synthesis of which is issued by the command issuing unit and to process one of the two images so as to fit the other image in image capturing conditions; and an image synthesis unit configured to synthesize a resulting processed version of the one image with the other image.

In accordance with another aspect of the present invention, there is provided a software program product embodied in a computer readable medium for causing a computer for an image processor to function as: a position specifying unit configured to specify the position of a light source image in one of at least two images; and a position indicating unit configured to indicate a position(s) in the one image where the remaining one(s) of the at least two images are synthesized; and a synthesis unit configured to process the remaining one(s) of the at least two images based on the position of the light source image in the one image and the position(s) in the one image indicated by the position indicating unit, and to synthesize a resulting processed version(s) of the remaining one(s) of the at least two images with the one image.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention.

FIG. 1 illustrates the structure of a camera device as an embodiment 1 of the present invention.

FIG. 2 is a flowchart indicative of one example of a background image producing process which will be performed by the camera device.

FIG. 3 is a flowchart indicative of one example of a subject-image cutout process which will be performed by the camera device.

FIG. 4 is a flowchart indicative of one example of a synthesized image producing process which will be performed by the camera device.

FIG. 5 schematically illustrates the details of step S38 of the flowchart of FIG. 4.

FIG. 6A schematically illustrates one example of an image involved in the synthesized image producing process of FIG. 4.

FIG. 6B illustrates another example of the image involved in the synthesized image producing process of FIG. 4.

FIG. 6C illustrates still another example of the image involved in the synthesized image producing process of FIG. 4.

FIG. 7 is a block diagram of a camera device as an embodiment 2 of the present invention.

FIG. 8 is a flowchart indicative of one example of a background image producing process which will be performed by the camera device of FIG. 7.

FIG. 9 is a flowchart indicative of one example of a subject-image cutout process which will be performed by the camera device of FIG. 7.

FIG. 10 is a flowchart indicative of one example of a synthesized image producing process which will be performed by the camera device of FIG. 7.

FIG. 11A schematically illustrates one example of an image involved in the synthesized image producing process of FIG. 10.

FIG. 11B schematically illustrates another example of the image involved in the synthesized image producing process of FIG. 10.

FIG. 11C schematically illustrates still another example of the image involved in the synthesized image producing process of FIG. 10.

FIG. 12A illustrates one example of a synthesized image of a subject and a background image.

FIG. 12B illustrates another example of the synthesized image of FIG. 12A.

### DETAILED DESCRIPTION TO THE INVENTION

Referring to the accompanying drawings, embodiments of the present invention will be described specifically below.

### Embodiment 1

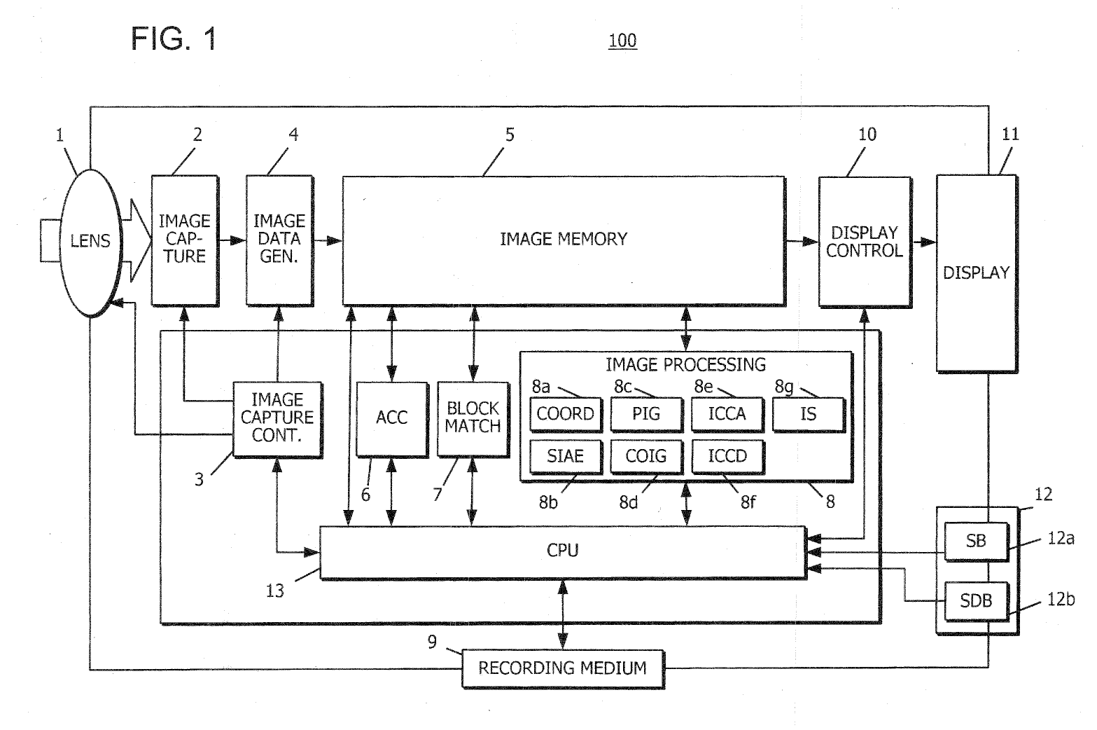

FIG. 1 illustrates the structure of a camera device 100 of the embodiment 1 related to the present invention. The camera device 100 includes an image capturing condition determiner 8f which determines whether an image of a background (for example, of a scene) P1 coincides in image capturing conditions including brightness, contrast, and color tone with an image of a subject P3. If not, an image synthesis unit 8g of the camera device 100 performs a predetermined process on the subject image P3 and then synthesizes a resulting image and the background image P1.

More specifically, as shown in FIG. 1, the camera device 100 comprises a lens unit 1, an electronic image capture unit 2, an image capture control unit 3, an image data generator 4, an image memory 5, an amount-of-characteristic computing (ACC) unit 6, a block matching unit 7, an image processing subunit 8, a recording medium 9, a display controller 10, a display 11, an operator input unit 12 and a CPU 13.

The image capture control unit 3, amount-of-characteristic computing unit 6, block matching unit 7, image processing subunit 8, and CPU 13 are incorporated, for example, as a custom LSI in the camera. The lens unit 1 is composed of a plurality of lenses including a zoom and a focus lens. The lens unit 1 may include a zoom driver (not shown) which moves the zoom lens along an optical axis thereof when a subject image is captured, and a focusing driver (not shown) which moves the focus lens along the optical axis.

The electronic image capture unit 2 comprises an image sensor such as, for example, a CCD (Charge Coupled Device) or a CMOS (Complementary Metal-Oxide Semiconductor) sensor which functions to convert an optical image which has passed through the respective lenses of the lens unit 1 to a 2-dimensional image signal.

The image capture control unit 3 comprises a timing generator and a driver (none of which are not shown) to cause the electronic image capture unit 2 to scan and periodically convert an optical image to a 2-dimensional image signal, reads image frames on a one-by-one basis from an imaging area of the electronic image capture unit 2 and then outputs them to the image data generator 4.

The image capture control unit 3 adjusts conditions for capturing an image of the subject by performing an AF (Auto Focusing), an AE (Auto Exposing) and an AWB (Auto White Balancing) process.

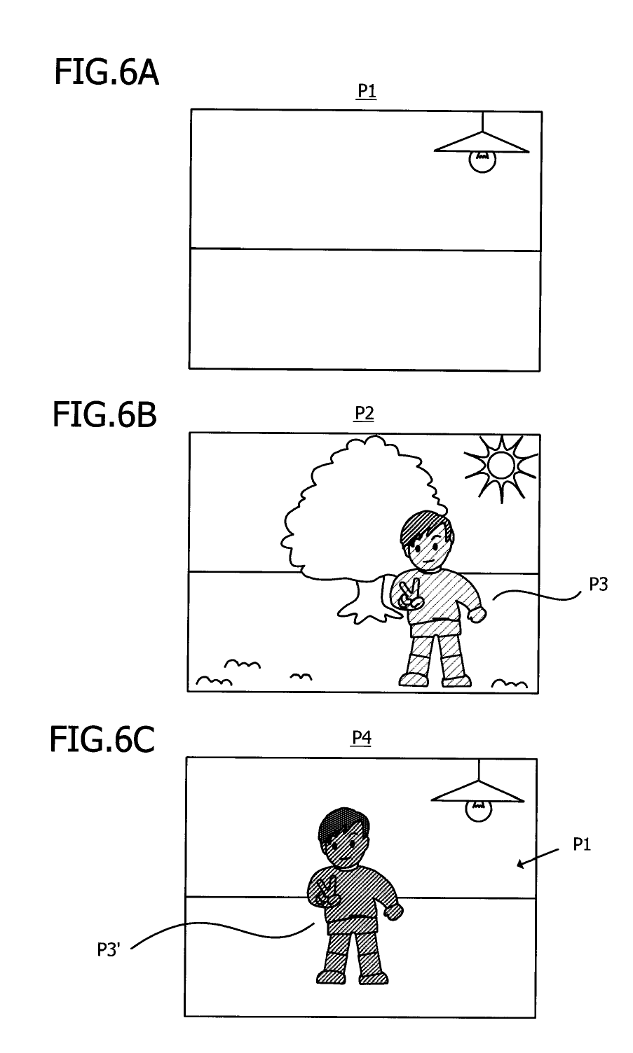

The imaging lens unit 1, the electronic image capture unit 2 and the image capture control unit 3 cooperate to capture a background-only image P1 of a background only (see FIG. 6A) and a subject-background image P2 (see FIG. 6B) which is an image of a specified subject and its background which are involved in the image synthesizing process.

After the subject-background image P2 has been captured, the lens unit 1, the capture unit 2 and the image capture control unit 3 cooperate to capture the background-only image from the subject-background image P2 to produce a subject image P3 contained in the subject-background image P2 in a state where the conditions for capturing the subject-background image P2 are fixed.

The image data generator 4 appropriately adjusts the gain of each of R, G and B color components of an analog signal representing an image frame transferred from the electronic image capture unit 2; samples and holds a resulting analog signal in a sample and hold circuit (not shown) thereof, converts a second resulting signal to digital data in an A/D converter (not shown) thereof; performs, on the digital data, a color processing process including a pixel interpolating process and a γ-correcting process in a color processing circuit (not shown) thereof, and then generates a digital luminance signal Y and color difference signals Cb, Cr (YUV data).

The luminance signal Y and color difference signals Cb, Cr outputted from the color processing circuit are DMA transferred via a DMA controller (not shown) to the image memory 5 which is used as a buffer memory.

The image memory 5 comprises, for example, a DRAM which temporarily stores data processed and to be processed by the amount-of-characteristic computing unit 6, block matching unit 7, image processing subunit 8 and CPU 13.

The amount-of-characteristic computing unit 6 performs a characteristic extracting process which includes extracting characteristic points from the background-only image based on same. More specifically, the amount-of-characteristic computing unit 6 selects a predetermined number of or more block areas of high characteristics (characteristic points) based on the YUV data of the background-only image and extracts the contents of these block areas as a template (for example, of a square of 16×16 pixels).

The characteristic extracting process includes selecting block areas of high characteristics convenient to track from among many candidate blocks.

The block matching unit 7 performs a block matching process for causing the background-only image and the subject-background image P2 to coordinate with each other. More specifically, the block matching unit 7 searches for areas or locations in the subject-background image P2 where the pixel values of the subject-background image P2 correspond to the pixel values of the template.

In other words, the block matching unit 7 searches for locations or areas in the subject-background image P2 where the pixels of the subject-background image P2 optimally match those of the template. Then, the block matching unit 7 computes a degree of dissimilarity between each pair of corresponding pixel values of the template and the subject-background image P2 and the template in a respective one of the locations or areas; computes, for each location or block area, an evaluation value involving all those degrees of dissimilarity (for example, represented by Sum of Squared Differences (SSD) or Sum of Absolute Differences (SAD)); and also computes, as a motion vector for the template, an optimal offset between the background-only image and the subject-background image based on the smallest one of the evaluated values.

The image processing subunit 8 includes a coordination (COORD) unit 8a which coordinates the background-only image and the subject-background image P2. More particularly, the coordination unit 8a computes a coordinate transformation expression (projective transformation matrix) for the respective pixels of the subject-background image P2 to the background-only image based on the characteristic points extracted from the background-only image; performs the coordinate-transformation on the subject-background image P2 in accordance with the coordinate transform expression; and then coordinates a resulting image and the background-only image.

The image processing subunit 8 generates difference information between each pair of corresponding pixels of the background-only image and the subject-background image P2 which are coordianted by the coordination unit 8a. In addition, the image processing subunit 8 includes a subject-image area extractor (SIAE) 8b which extracts an area of the subject image from the subject-background picture P2 based on the difference information.

The image processing subunit 8 also includes a position information generator (PIG) 8c which specifies the position of the subject image extracted from the subject-background image P2 and generates information on the position of the image of the subject in the subject-background image P2.

An alpha map is mentioned, for example, as position information, in which map the pixels of the subject-background image P2 each are given a weight represented by an alpha (α) value where 0≦α≦1 with which the subject image is alpha blended with a predetermined background.

The image processing subunit 8 includes a cutout image generator (COIG) 8d which synthesizes a subject image and a predetermined monochromatic image (not shown), thereby generating image data of a subject image P3 (see FIG. 6C) such that among the pixels of the subject-background image P2, pixels with an alpha value of 0 are not displayed to the monochromatic image based on the produced alpha map and that pixels with an alpha value of 1 are displayed.

The image processing subunit 8 comprises an image capturing condition acquirer (ICCA) 8e which acquires image capturing conditions as information related to an image synthesizing process for each image. The image capturing conditions include, for example, brightness, contrast and color tone. The image capturing condition acquirer 8e acquires a brightness and contrast of each of the background image P1 produced by the image data generator 4 and the subject image P3 produced by the cutout image generator 8d based on image data on those images P1 and P3.

The image condition acquirer 8e also acquires adjusted values of white balance as a color tone from the image capture control unit 3 when the background and subject images P1 and P3 are captured. The image capturing condition acquirer 8e further reads and acquires image capturing conditions including the brightness, contrast and adjusted white balance value (color tone) of the background and subject images P1 and P3 from the Exif information of their image data recorded as an image file of an Exif type on the recording medium 9, in the synthesized image producing process.

Further, the image capturing condition acquirer 8e acquires image capturing conditions related to the image synthesizing process for the (first or) background image P1. Then, the image capturing condition acquirer 8e acquires, as conditions for capturing the (second or) subject image P3, the image capturing conditions under which the subject-background image P2 involving the production of the (second or) subject image P3 was captured.

The image processing subunit 8 comprises an image capturing condition determiner (ICCD) 8f which determines whether the image capturing conditions for the background picture P1 acquired by the image capturing condition acquirer 8e coincide with those for the subject image P3 acquired likewise. More specifically, the image capturing condition determiner 8f determines whether the conditions for capturing the background image P1 which will be the background of a synthesized image specified by the user coincide with those for capturing the subject picture P3 specified likewise by the user, in the synthesized image producing process.

The image capturing condition determiner 8f determines whether the conditions for capturing the (first or) background image P1 acquired by the image capturing condition acquirer 8e coincide with those for capturing the (second or) subject image P3.

The image processing subunit 8 also comprises an image synthesis unit 8g which synthesizes the subject and background images P3 and P1. More specifically, when commanded to synthesize the background image P1 and the subject image P3, the image synthesis unit 8g synthesizes the background image P1 and the subject image P3 such that the subject image P3 is superimposed on the background image P1. For a resulting synthesized image, when a pixel of the subject image P3 has an alpha value of 1, a corresponding pixel of the background image P1 is not displayed on a resulting synthesized image. When a pixel of the subject image P3 has an alpha value of 1, a corresponding pixel of the background image P1 is overwritten with a value of that pixel of the subject image P3.

Further, when a pixel of the subject image P3 has an alpha (α) value where 0<α<1, the image synthesis unit 8g removes, from the background image P1, an area in the background image P1 where the subject image P3 is superimposed on the background image P1, using a 1's complement of 1 (or (1−α)) in the alpha map, thereby producing a subject area-free background image (background image×(1−α)). The image synthesis unit 8g then computes the pixel value of the monochromatic image used when the subject image P3 was produced, using the 1's complement of 1 (or (1−α)) in the alpha map. Then, the image synthesis unit 8g subtracts the computed pixel value of the monochromatic image from the pixel value of a monochromatic image formed potentially in the subject image P3, thereby eliminating the potentially formed monochromatic image from the subject image P3. Then, the image synthesis unit 8g synthesizes a resulting processed version of the subject image P3 with the subject-free background image (or background image×(1−α)).

The image synthesis unit 8g also synthesizes the subject image P3 and the background image P1 based on the image capturing conditions for the subject and background images P3 and P1 acquired by the image capturing conditions acquirer 8e. More specifically, first, when the image capturing condition determiner 8f determines that the image capturing conditions for the background image P1 do not coincide with those for the subject image P3, the image synthesis unit 8g adjusts the brightness, contrast and white balance of the subject image P3 so as to coincide with those of the background image P1 and then synthesizes a resulting processed version of the subject image P3 and the background image P1, thereby producing a synthesized image P4.

The recoding medium 9 comprises, for example, a non-volatile (flash) memory which stores image data of the background image P1 and subject image P3 encoded by a JPEG compressor (not shown) of the image processing subunit 8.

The image data of the subject image P3 with an extension “.jpe” is stored in correspondence to the alpha map produced by the position information generator 8c.

Each image data is composed of an image file of an Exif type including, as incidental Exif information, image capturing conditions including the brightness, contrast and adjusted white balance value (color tone).

The display control unit 10 reads image data for display stored temporarily in the image memory 5 and displays it on the display 11. More specifically, the display control unit 10 comprises a VRAM, a VRAM controller, and a digital video encoder (none of which are shown). The video encoder periodically reads the luminance signal Y and color difference signals Cb, Cr, read from the image memory 5 and stored in the VRAM under control of CPU 13, from the VRAM via the VRAM controller. Then the display control unit 10 generates a video signal based on these data and then displays the video signal on the display 11.

The display 11 comprises, for example, a liquid crystal display which displays an image captured by the electronic image capturer 2 based on the video signal from the display control unit 10. More specifically, in the image capturing mode, the display 11 displays live view images based on the respective image frames of the subject captured by cooperation of the lens unit 1, the electronic image capturer 2 and the image capture control unit 3, and also displays an actually captured version of a particular one of live view images displayed on the display 11.

The operator input unit 12 is used to operate the camera device 100. More specifically, the operator input unit 12 comprises a shutter push-button 12a to give a command to capture an image of a subject, a selection/determination push-button 12b which, in accordance with a manner of operating the push-button, selects and gives one of commands including a command to select one of a plurality of image capturing modes or functions or one of a plurality of displayed images, a command to set image capturing conditions and a command to set a synthesizing position of the subject image P3, and a zoom push-button (not shown) which gives a command to adjust a quantity of zooming. The operator input unit 12 provides an operation command signal to CPU 13 in accordance with operation of a respective one of these push-buttons.

CPU 13 controls associated elements of the camera device 100, more specifically, in accordance with corresponding processing programs (not shown) stored in the camera.

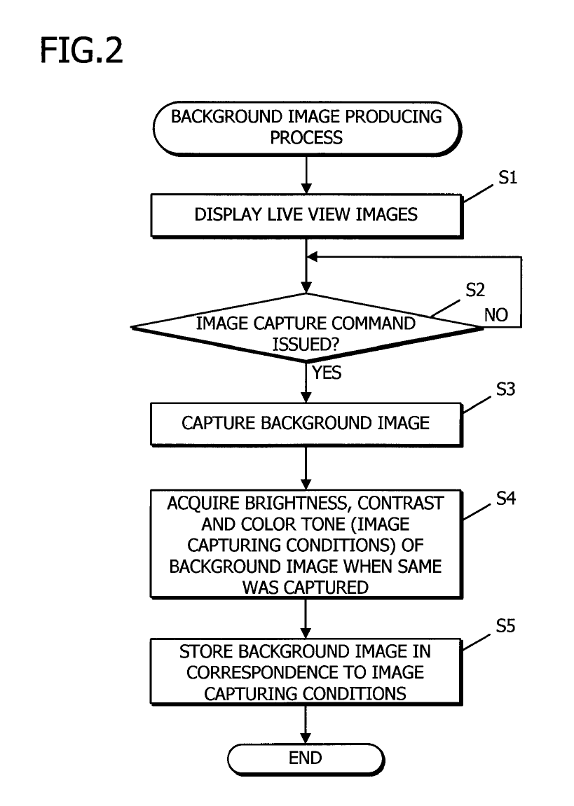

Referring to a flowchart of FIG. 2, a background image producing process which will be performed by the camera device 100 will be described. Assume that in this process the background image P1 is captured within a room. This image should be different, for example, in brightness, contrast and color tone from a subject-background image P2 to be captured outside.

The background image producing process is an ordinary process for capturing a still image of a subject. This process is performed when a still image capturing mode is selected from among the plurality of image capturing modes displayed on a menu picture, by the operation of the push-button 12b of the operator input unit 12.

As shown in FIG. 2, first, CPU 13 causes the display controller 10 to display live view images on the display 11 based on respective image frames of the background image P1 captured by cooperation of the image capturing lens unit 1, the electronic image capture unit 2 and the image capture control unit 3 (step S1).

Then, CPU 13 determines whether the shutter push-button 12a of the operator input unit 12 has been operated (step S2). If it does (YES in step S2), CPU 13 causes the image capture control unit 3 to adjust a focused position of the focus lens, exposure conditions (including shutter speed, stop and amplification factor) and white balance. Then, CPU 13 causes the electronic image capture unit 2 to capture an optical image of the background image P1 (see FIG. 6A) under predetermined conditions (step S3).

Then, CPU 13 causes the image data generator 4 to generate YUV data of the image frames of the background image P1 received from the electronic image capture unit 2. Then, CPU 13 causes the image capturing condition acquirer 8e of the image processing subunit 8 to acquire the brightness and contrast of the image as the image capturing conditions based on the YUV data of the background image P1 and then causes the image capturing condition acquirer 8e to acquire, as a color tone, the adjusted white balance value used when the background image P1 was captured from the image capture control unit 3 (step S4).

Then, CPU 13 stores, in a predetermined storage area of the recording medium 9, the YUV data of the background image P1 as an image file of an Exif type where the image capturing conditions (including brightness, contrast and color tone of the image) acquired by the image capturing condition acquirer 8e are annexed as Exif information (step S5). Then, the background image producing process is terminated.

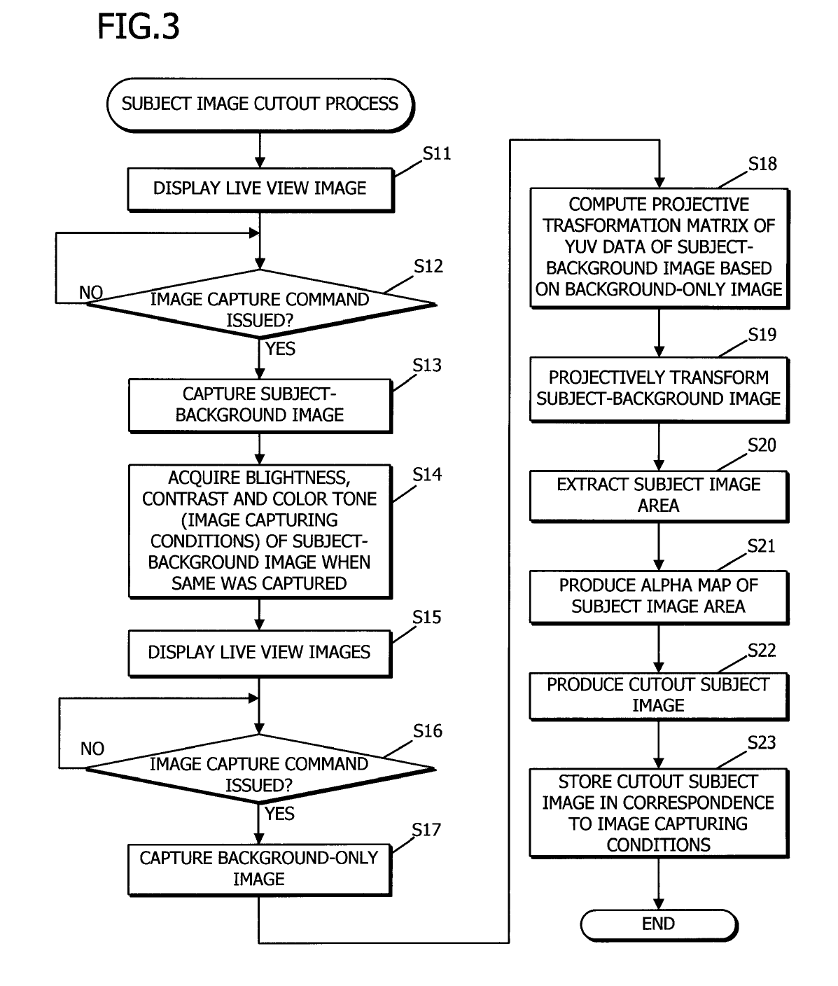

Referring to a flowchart of FIG. 3, a particular-subject image cutout process of the camera device 100 will be described. Now, assume that in this process, a subject-background image P2 is captured outdoors. The brightness of the subject-background image P2 and the subject images P3 of the FIGS. 6B and 6C is represented by a density of hatch lines drawn on the images of FIGS. 6B and 6C. It is meant in FIGS. 6A-C that as the density of the hatch lines is lower, the image is brighter.

The subject image cutout process is performed when a subject image cutout mode is selected from among the plurality of image capturing modes displayed on a menu picture based on the operation of the push-button 12b of the operator input unit 12.

As shown in FIG. 3, first, CPU 13 causes the display control unit 10 to display, on the display 11, live view images based on respective image frames of the subject captured by cooperation of the lens unit 1, the electronic image capture unit 2 and the image capture control unit 3, and also display a command message to capture the subject-background image P2 in a manner superimposed on the live view images (step S11).

Then, CPU 13 determines whether the shutter push-button 12a of the operator input unit 12 has been operated (step S12). If it does (YES in step S12), CPU 13 causes the image capture control unit 3 to adjust a focused position of the focus lens, exposure conditions (including the shutter speed, stop and amplification factor) and the white balance, thereby causing the electronic image capture unit 2 to capture an optical image indicative of the subject-background image P2 (see FIG. 6B) under the predetermined conditions (step S13).

Subsequently, CPU 13 causes the image data generator 4 to generate YUV data of the image frame of the subject-background image P2 received from the electronic image capture unit 2 and causes the image capturing condition acquirer 8e of the image processing subunit 8 to acquire, as image capturing conditions, the brightness and contrast of the subject-background image P2 based on its YUV data; and also acquire, as a color tone from the image capture control unit 3, an adjusted white balance value set when the subject-background image P2 was captured (step S14). The YUV data of the subject-background image P2 generated by the image data generator 4 is stored temporarily in the image memory 5.

CPU 13 also controls the image capture control unit 3 to maintain, in a fixed state, the focused position, exposure conditions and white balance set when the background image P2 was captured.

CPU 13 also causes the display control unit 10 to display live view images on the display 11 based on respective image frames of the subject image captured by the cooperation of the lens unit 1, the electronic image capture unit 2 and the image capture control unit 3. Then, CPU 13 causes the display 11 to display a message to capture a translucent version of the subject-background image P2 and the background-only image with the plurality of image frames superimposed, respectively, on the live view images (step S15).

Then, CPU 13 determines whether the shutter push-button 12a of the operator input unit 12 has been operated (step S16). Then, the user moves the subject image out of the angle of view or otherwise waits for the subject image to move out of the angle of view. Then, the user adjusts the position of the camera so as to coordinate the background-only image and the translucent version of the subject-background image P2.

Then, when determining that the shutter push-button 12a has been operated (YES in step S16), CPU 13 controls the image capture control unit 3 such that the image capture unit 2 captures an optical image indicative of the background-only image under the fixed conditions after the subject-background image P2 is captured (step S17).

Then, CPU 13 causes the image data generator 4 to generate YUV data of the background-only image based on its image frames received from the electronic image capture unit 2 and then stores the YUV data temporarily in the image memory 5.

Then, CPU 13 causes the amount-of-characteristic computing unit 6, the block matching unit 7 and the image processing subunit 8 to cooperate to compute, in a predetermined image transformation model (such as, for example, a similar transformation model or a congruent transformation model), a projective transformation matrix to projectively transform the YUV data of the subject-background image P2 based on the YUV data of the background-only image stored temporarily in the image memory 5 (step S18).

More specifically, the amount-of-characteristic computing unit 6 selects a predetermined number of or more block areas (characteristics points) of high characteristics based on the YUV data of the background—only image and then extracts the contents of the block areas as a template.

Then, the block matching unit 7 searches for locations or areas of pixel values of the subject-background image P2 which the pixel values of each template extracted in the characteristic extracting process optimally match; computes a degree of dissimilarity between each pair of corresponding pixel values of the template and the subject-background image; and also computes, as a motion vector for the template, an optimal offset between the background-only image and the subject-background image P2 based on the smallest one of the evaluated values.

Then, the coordination unit 8a of the image processing subunit 8 statistically computes a whole motion vector based on the motion vectors for the plurality of templates computed by the block matching unit 7, and then computes a projective conversion matrix of the subject-background image P2 using characteristic point correspondence involving the whole motion vector.

Then, CPU 13 causes the coordination unit 8a to projectively transform the subject-background image P2 based on the computed projective transformation matrix, thereby coordinating the YUV data of the subject-background image P2 and that of the background-only image (step S19).

Then, CPU 13 causes the subject image area extractor 8b of the image processing subunit 8 to extract an area of the subject image from the subject-background image P2 (step S20). More specifically, the subject image area extractor 8b causes the YUV data of each of the subject-background image P2 and the background-only image to pass through a low pass filter to eliminate high frequency components of the respective images.

Then, the subject image area extractor 8b computes a degree of dissimilarity between each pair of corresponding pixels in the subject-background and background-only images P2 and P1 passed through the low pass filters, respectively, thereby producing a dissimilarity degree map. Then, the subject image area extractor 8b binarises the map with a predetermined threshold, and then performs a shrinking process to eliminate, from the dissimilarity degree map, areas where dissimilarity has occurred due to fine noise and/or blurs.

Then, the subject image area extractor 8b performs a labeling process on the dissimilarity degree map to specify a pattern of a maximum area in the dissimilarity degree map as the subject image area; and then performs an expanding process to correct possible shrinks which have occurred to the subject image area.

Then, CPU 13 causes the position information generator 8c of the image processing subunit 8 to produce an alpha map indicative of the position of the extracted subject image area in the subject-background image P2 (step S21).

Then, CPU 13 causes the cutout image generator 8d of the image processing subunit 8 to generate image data of a synthesized subject image P3 (see FIG. 6C) of the subject image and a predetermined monochromatic image (step S22).

More specifically, the cutout image generator 8d reads data on the subject-background image P2, the monochromatic image and the alpha map from the recording medium 9; loads these data on the image memory 5, causes pixels of the image P2 with an alpha value of 0 not to be displayed to the monochromatic image; causes pixels with an alpha value greater than 0 and smaller than 1 to blend with a predetermined monochromatic pixel; and causes pixels with an alpha value of 1 to be rendered to the predetermined monochromatic pixel and subjected to no other processes.

Then, CPU 13 forms the YUV data of the subject image P3 into an image file of an Exif type to which the image capturing conditions (including the brightness, contrast and color tone of the image) acquired by the image capturing condition acquirer 8e and the alpha map produced by the position information generator 8c are annexed as Exif information. Then, this image file is stored with an extension “.jpe” annexed to the image data of the subject image P3 in a predetermined storage area of the recording medium 9 (step S23). Thus, the subject image cutout process is terminated.

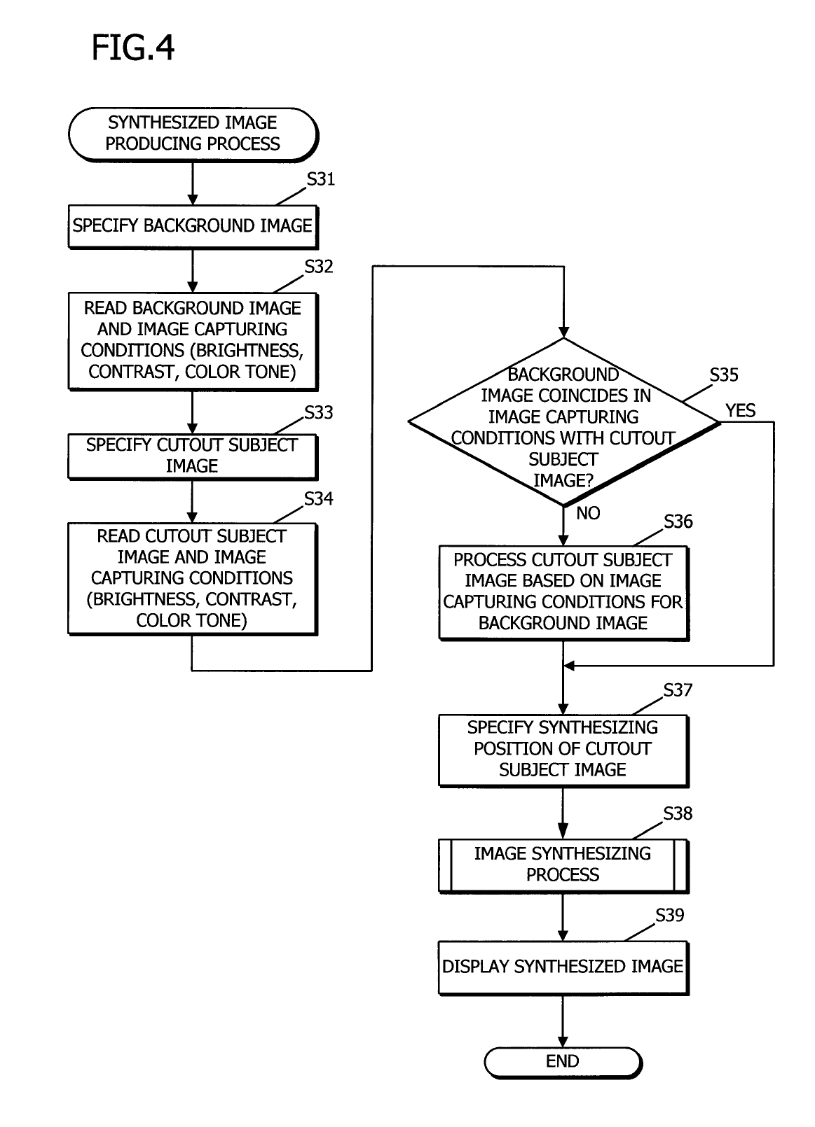

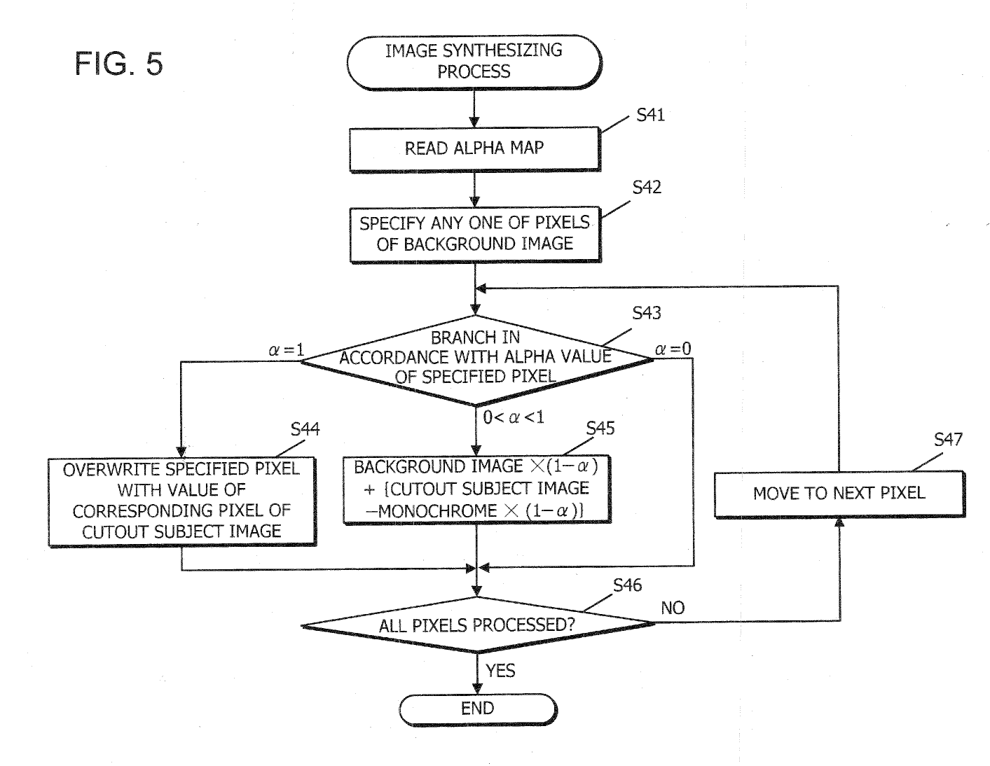

Then, referring to FIGS. 4 and 5, a synthesized image producing process will be described in detail. FIG. 4 is a flowchart indicative of one example of the synthesized image producing process. FIG. 5 is a flowchart indicative of one example of an image synthesizing step S38 of the synthesized image producing process of FIG. 4.

The synthesized image producing process is performed when an image synthesis mode is selected from among the plurality of image capture modes displayed on the menu picture by the operation of the push-button 12b of the operator input unit 12.

As shown in FIG. 4, when a desired background image P1 (see FIG. 6A) which will be the background of a synthesized image is selected from among a plurality of images recorded on the recording medium 9 by a predetermined operation of the operator input unit 12 (step S31), the image processing subunit 8 reads image data of the background image P1 and loads it on the image memory 5. Then, the image capturing condition acquirer 8e reads and acquires the image capturing conditions (i.e., brightness, contrast and color tone of the image) stored on the recording medium 9 in correspondence to the image data (step S32).

Then, when a desired subject image P3 is selected from among the plurality of images stored on the recording medium 9 by a predetermined operation of the operator input unit 12 (step S33), the image processing subunit 8 reads the image data of the selected subject image P3 and loads it on the image memory 5. At this time, the image capturing condition acquirer 8e reads and acquires the image capturing conditions (i.e., brightness, contrast and color tone of the image) stored on the recording medium 9 in correspondence to the image data (step S34).

Subsequently, the image capturing condition determiner 8f of the image processing subunit 8 determines whether the read background image P1 coincide with the subject image P3 in image capturing conditions (i.e., brightness, contrast and color tone) (step S35).

If it does not (NO in step S35), the image synthesis unit 8g performs a predetermined image processing process such that the image capturing conditions for the subject image P3 fit those for the background image P1 (step S36).

More specifically, when the background image P1 does not coincide in brightness with the subject image P3, the image synthesis unit 8g adjusts that condition for the subject image P3 so as to fit that for the background image P1. The same is true of contrast and white balance.

When the image capturing condition determiner 8f determines in step S35 that the image capturing conditions for the image P1 coincide with those for the subject image P3 (YES in step S35), the image synthesis unit 8g performs step S37 and subsequent steps without performing step S36 on the subject image P3.

When a synthesizing position of the subject image P3 in the background image P1 is specified by a predetermined operation on the operator input unit 12 (step S37), the image synthesis unit 8g synthesizes the background image P1 and the subject image P3 (including an image processed in step S36) (step S38).

The process for specifying the synthesizing position of the subject image P3 in the background image P1 (step S37) may be performed at any timing point as long as it is performed before the image synthesizing process (step S38).

Now, referring to FIG. 5, the image synthesizing process will be described. As shown in FIG. 5, the image synthesis unit 8g reads the alpha map stored on the recording medium 9 in correspondence to the subject image P3 and loads it in the image memory 5 (step S41).

When the synthesizing position of the subject image P3 in the background image P1 is specified in step S37 of FIG. 4, the background image P1 may be displaced from the alpha map. In this case, the image synthesis unit 8g gives an alpha value of 0 to the outside of the alpha map, thereby preventing areas with no alpha values from occurring.

Then, the image synthesis unit 8g specifies any one (for example, an upper left corner pixel) of the pixels of the background image P1 (step S42) and then causes the processing of the pixel to branch to a step specified in accordance with an alpha value (α) of a corresponding pixel of the subject image P3 (step S43).

More specifically, when at this time a corresponding pixel of the subject image P3 has an alpha value of 1 (step S43, α=1), the image synthesis unit 8g overwrites the specified pixel of the image P1 with the pixel value of the corresponding pixel of the subject image P3 (step S44).

Further, when the corresponding pixel of the subject image P3 has an alpha (α) value where 0<α<1 (step S43, 0<α<1), the image synthesis unit 8g removes, from the background image P1, an area in the background image P1 where the subject image P3 is superimposed on the background image P1, using a 1's complement of 1 (or (1−α)) in the alpha map, thereby producing a subject area-free background image (background image×(1−α)). The image synthesis unit 8g then computes the pixel value of the monochromatic image used when the subject image P3 was produced, using the 1's complement of 1 (or (1−α)) in the alpha map. Then, the image synthesis unit 8g subtracts the computed pixel value of the monochromatic image from the pixel value of a monochromatic image formed potentially in the subject image P3, thereby eliminating the potentially formed monochromatic image from the subject image P3. Then, the image synthesis unit 8g synthesizes a resulting processed version of the subject image P3 with the subject-free background image (or background image×(1−α)) (step S45).

For a pixel with an alpha value of 0 (step S43, α=0), the image synthesis unit 8g performs no image processing process on the pixel excluding displaying the background image P1.

Then, the image synthesis unit 8g determines whether all the pixels of the background image P1 have been processed (step S46). If it does not, the image synthesis unit 8g shifts its processing to a next pixel (step S47) and then to step S43.

By iterating the above steps S43 to S46 until the image synthesis unit 8g determines that all the pixels have been processed (YES in step S46), the image synthesis unit 8g generates image data of a synthesized image P4 of the subject image P3 and the background image P1, and then terminates the image composing process.

Then, as shown in FIG. 4, CPU 13 controls the display control unit 10 such that the display 11 displays the synthesized image P4 (see FIG. 6C) where the subject image P3 is superimposed on the background image P1, based on image data of the synthesized image P4 produced by the image synthesis unit 8g (step S39), and then terminates the synthesized image producing process.

As described above, according to the camera 100 of the embodiment 1, the image synthesis unit 8g synthesizes the background image P1 and the subject image P3, thereby producing the synthesized image P4, based on the image capturing conditions for the images P1 and P3 acquired by the image capturing condition acquirer 8e.

More specifically, after the electronic image capture unit 2 captures the subject-background image P2 under the predetermined image capturing conditions, the cutout image generator unit 8d produces the subject image P3 from the subject-background image P2. Then, the image capturing condition acquirer 8e acquires image capturing conditions including the brightness, contrast and color tone of the images P1 and P3. Then, the image capturing condition determiner 8f determines whether the image capturing conditions for the image P1 coincide with those for the subject image P3.

If it does not, the image synthesis unit 8g performs the predetermined image processing process on the subject image P3 such that its image capturing conditions for the subject image P3 fit those for the image P1.

Then, the image synthesis unit 8g synthesizes the subject image P3 and the background image P1. Thus, when the image capturing conditions for the subject image P3 are different from those for the background image P1, the image synthesis unit 8g can perform the image processing process such that the image capturing conditions for the subject image P3 fit those for the image P1. Thus, the image synthesis unit 8g produces a synthesized image P4 including a subject image P3′ giving little sense of discomfort.

In the above embodiment 1, when the image capturing condition determiner 8f determines that the image capturing conditions for the image P1 do not coincide with those for the subject image P3, the image synthesis unit 8g performs the image processing process on the subject image P3 such that the image capturing conditions for the subject image P3 fit those for the image P1, and then synthesizes a resulting processed version of the subject image P3 with the image P3.

However, the structure of the image synthesis unit 8g is not limited to the specified example of the embodiment 1 and it may perform an image processing process on the background image P1 so as to synthesize a resulting processed version of the background image P1 and the subject image P3.

Alternatively, the image synthesis unit 8g may perform image processing processes on both the images P3 and P1 such that the image capturing conditions for both the images fit each other, and then synthesizes resulting images.

### Embodiment 2

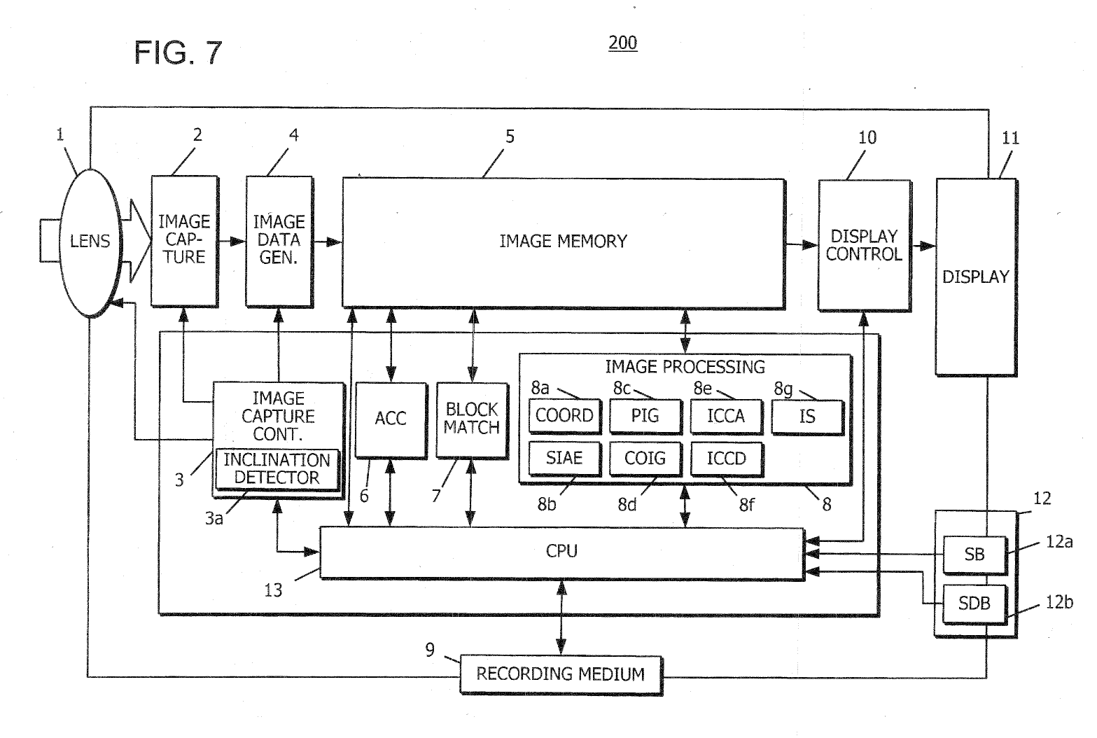

Referring to FIGS. 7-11, a camera device 200 of an embodiment 2 will be described. As shown in FIGS. 7-11, the camera device 200 determines whether a background image P11 coincides in angle of inclination to the horizontal (image capturing conditions) with a subject image P13. If it does not, the camera 200 rotates the subject image P13 such that its inclination coincides with that of the background image P11, and then synthesizes both a resulting rotated version of the subject image P13 and the background image P11.

The camera 200 is similar in structure to the camera 100 of the embodiment 1 except for the structure of the image capture control unit 3 and the content of the image capturing conditions, and further description of the similar structural points of the camera 200 will be omitted

The image capture control unit 3 of the camera device 200 comprises an inclination detector 3a which detects an inclination of the camera 200 to the horizontal when capturing the subject image in cooperation with an image capturing lens unit 1 and an electronic image capture unit 2.

The inclination detector 3a comprises an electronic level which includes an acceleration sensor and an angular speed sensor (none of which are shown). The inclination detector 3a forwards, to the CPU 13, as information on the respective inclinations of the background image P11 and the subject-background image P12 (the image capturing conditions), the respective inclinations of the camera device 200 to the horizontal detected when the background image P11 and the subject-background image P12 are captured. The inclination of the camera device 200 to the horizontal is preferably detected as an angle rotated in a predetermined direction from the horizontal by taking account of the top and bottom of the image.

The inclination detector 3a acquires the image capturing conditions under which the (first or) background image P11 has been captured and the image capturing conditions, as the image capturing conditions for the (second or) subject image P13, under which the subject-background image P12 involving production of the subject image P13 was captured.

The inclination information (image capturing conditions) detected by the inclination detector 3a is annexed as Exif information to the image data of the background and subject images P11 and P13.

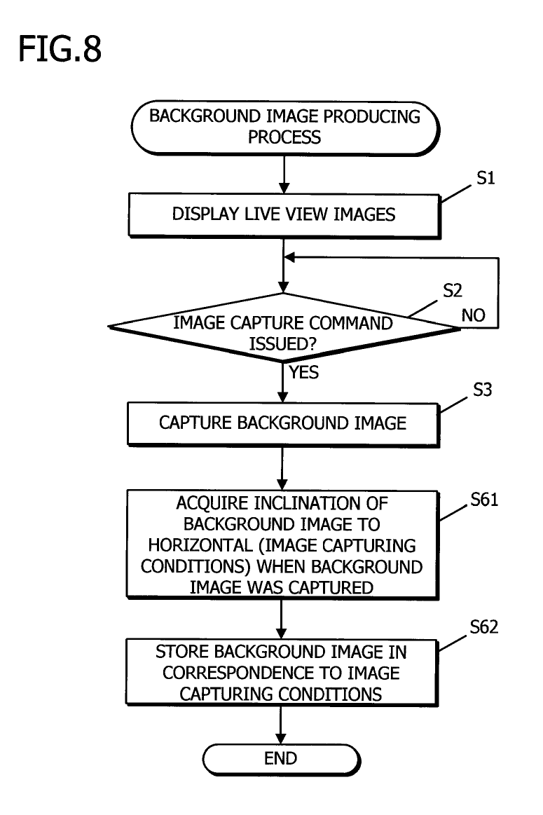

Then, referring to a flowchart of FIG. 8, a background image producing process will be described. The remainder of the background image producing process, which will be described below, excluding an inclination information acquiring process and an inclination information storing process, is similar to a corresponding part of the flowchart involving the embodiment 1 and further description thereof will be omitted.

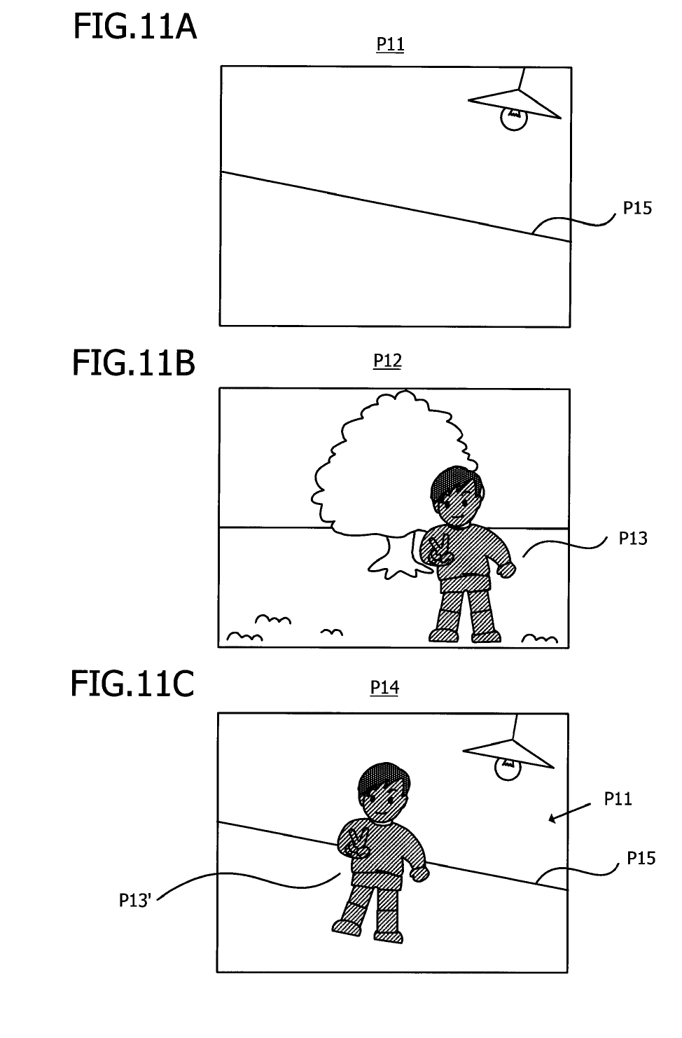

Assume that the background image P11 has been captured by the camera 200 inclined at a predetermined angle to the horizontal (see FIG. 11A).

As shown in FIG. 8, as in the embodiment 1, when determining that the shutter push-button 12a has been operated (YES in step S2) during display of live view images (step S1), CPU 13 causes the image capture control unit 3 to adjust the image capturing conditions including the focused position of the focus lens, the exposure conditions (including shutter speed, stop and amplification factor) and white balance and causes the electronic image capture unit 2 to capture an optical image of the background image P11 (see FIG. 11A) under the adjusted image capturing conditions (step S3).

At this time, the inclination detector 3a of the image capture control unit 3 detects an inclination of the camera 200 to the horizontal when the background image P11, where the horizontal is shown as a slope P15, is captured and then forwards the inclination information to CPU 13 (step S61).

Subsequently, CPU 13 causes the image data generator 4 to generate YUV data of image frames of the background image P11 received from the electronic image capture unit 2, stores the YUV in a predetermined storage area of the recording medium 9 as an image file of an Exif type to which the inclination information (image capturing conditions) acquired by the image capturing condition acquirer 8e is annexed as Exif information (step S62), and then terminates the background image producing process.

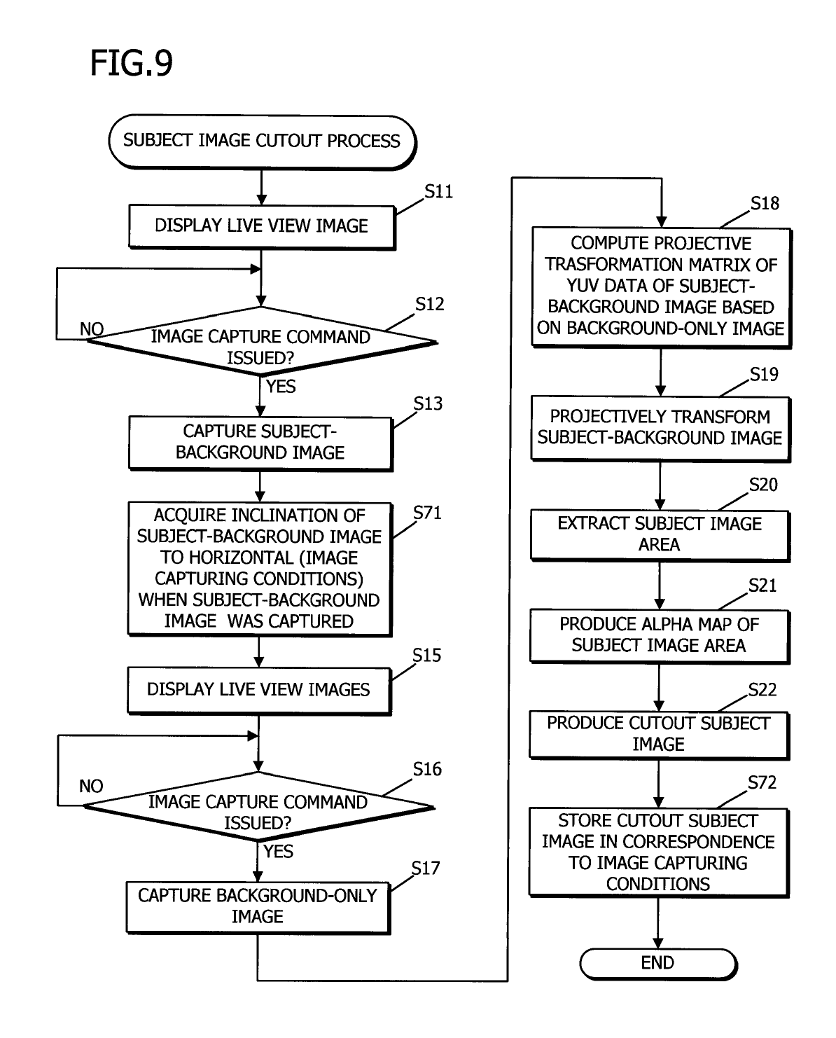

Referring to a flowchart of FIG. 9, a subject image cutout process will be described. Assume that a subject image P13 is captured by the camera 200 set in a horizontal state (see FIG. 11B).

As shown in FIG. 9, as in the embodiment 1, when determining (YES in step S12) that the shutter push-button 12a has been operated during display of live view images (step S11), CPU 13 causes the image capture control unit 3 to adjust the focused position of the focus lens, the exposure conditions (including the shutter speed, stop and amplification factor) and white balance. Then, CPU 13 causes the electronic image capture unit 2 to capture an optical image of the subject-background image P12 (see FIG. 11B) under the adjusted image capturing conditions (step S13).

At this time, the inclination detector 3a of the image capture control unit 3 detects an inclination of the camera 200 to the horizontal as the inclination of the subject-background image P12 to the horizontal when the image P12 was captured and then forwards the inclination information to CPU 13 (step S71).

Subsequently, as in the embodiment 1, CPU 13 causes the image data generator 4 to generate YUV data of image frames of the subject-background image P12 received from the electronic image capture unit 2, and then stores that YUV data temporarily in the image memory 5.

As in the embodiment 1, the user adjusts the position of the camera 200 such that the background-only image is coordinated with a translucent version of the subject-background image P12 during display of the live view images (step S15) and then operates the shutter push-button 12a. As a result, when determining that the shutter push-button 12a has been operated (Yes in step S16), CPU 13 controls the image capture control unit 3 such that the electronic image capture unit 2 captures an optical image indicative of the background only under fixed image capturing conditions after the subject-background image P12 is captured (step S17).

Then, as in the embodiment 1, CPU 13 causes the image data generator 4 to generate YUV data of the background-only image based on the image frames of the background-only image received from the electronic image capture unit 2 and then store the YUV data temporarily in the image memory 5.

Then, as in the embodiment 1, CPU 13 causes the amount-of-characteristic computing unit 6, the block matching unit 7 and the image processing subunit 8 to cooperate to compute, in a predetermined image transformation model (such as, for example, a similar transformation model or congruent transformation model), a projective transformation matrix to projectively transform the YUV data of the subject-background image P2 based on the YUV data of the background-only image stored temporarily in the image memory 5 (step S18).

Then, as in the embodiment 1, CPU 13 causes the coordination unit 8a of the image processing subunit 8 to projectively transform the subject-background image P12 based on the computed projective transformation matrix, thereby coordinating the YUV data of the image P12 and that of the background-only image (step S19).

Then, as in the embodiment 1, CPU 13 causes the subject image area extractor 8b of the image processing subunit 8 to extract an area of the subject image from the subject-background image P12 (step S20).

Then, as in the embodiment 1, CPU 13 causes the position information generator 8c of the image processing subunit 8 to produce an alpha map indicative of the position of the extracted subject image in the subject-background image P12 (step S21).

Then, as in the embodiment 1, CPU 13 causes the cutout image generator 8d of the image processing subunit 8 to generate image data of a synthesized image P13 of the subject image and a predetermined monochromatic image (step S22).

Then, CPU 13 forms the YUV data of the subject image P13 into an image file of an Exif type to which the inclination information (image capturing conditions) acquired by the image capturing condition acquirer 8e and the alpha map produced by the position information generator 8c are annexed as Exif information with an extension “.jpe” to the image data of the subject image P13, stores the image file in a predetermined storage area of the recording medium 9 (step S72) and then terminates the subject image cutout process.

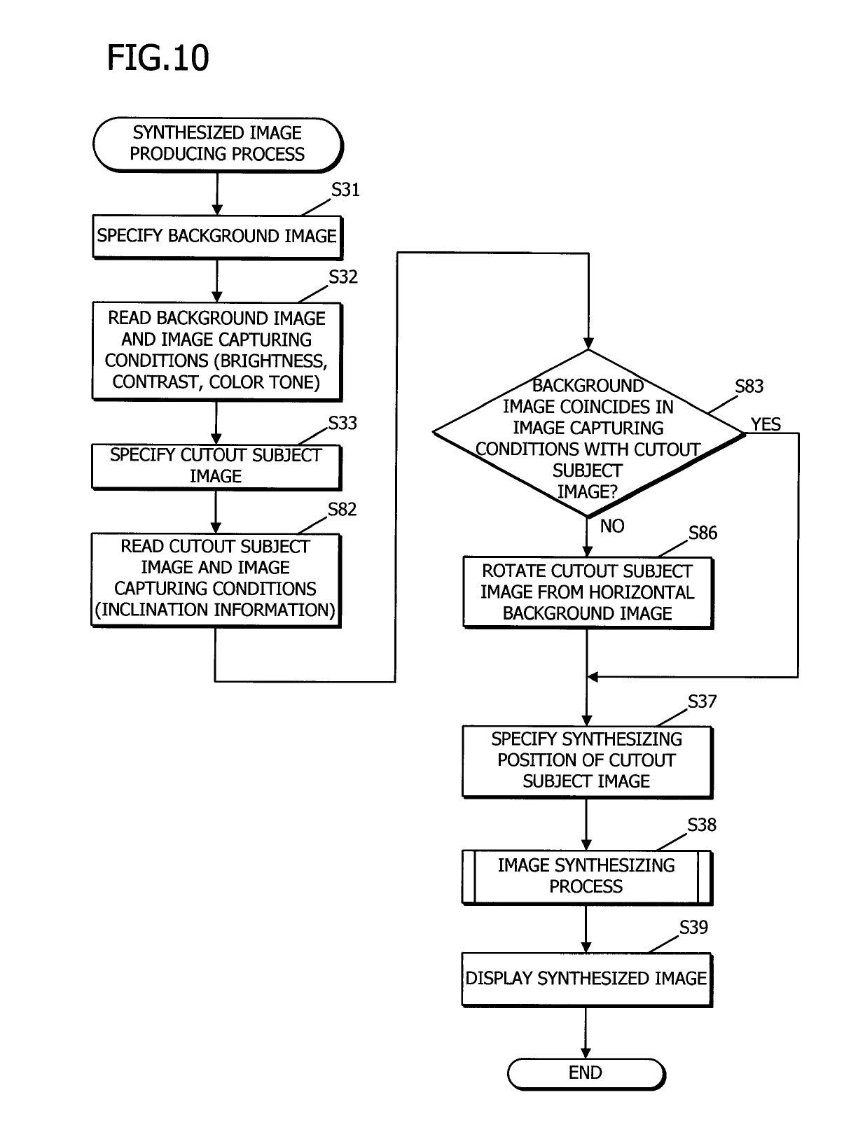

Now, referring to a flowchart of FIG. 10, a synthesized image producing process will be described in detail. As shown in FIG. 4, as in the embodiment 1, when a desired background image P11 (see FIG. 11A) which will be a background for a synthesized image is selected from among a plurality of images recorded on the recording medium 9 in accordance with a predetermined operation of the operator input unit 12 (step S31), the image processing subunit 8 reads image data of the selected background image P11 and loads it on the image memory 5.

Then, the image capturing condition acquirer 8e reads and acquires the image capturing conditions (or inclination information) stored on the recording medium 9 in correspondence to the image data (step S81).

Then, as in the embodiment 1, when a desired subject image P13 is selected from among the plurality of images stored on the recording medium 9 in accordance with the predetermined operation of the operator input unit 12 (step S33), the image processing subunit 8 reads the image data of the subject image P13 from the recording medium 9 and loads it on the image memory 5. Then, the image capturing condition acquirer 8e reads and acquires the image capturing conditions (inclination information) stored on the recording medium 9 in correspondence to the image data (step S82).

Subsequently, as in the embodiment 1, the image capturing condition determiner 8f determines whether the read background image P11 coincides with the subject image P13 in image capturing conditions (or inclination information) (step S83).

The background image P11 is captured by the camera device 200 inclined to the horizontal and the subject image P13 is contained in the subject-background image P12 captured by the camera 200 set in the horizontal. Thus, when CPU 13 determines that both the image capturing conditions (inclination information) for the images P11 and P13 do not coincide (NO in step S83), the image synthesis unit 8g performs a predetermined image rotation process on the subject image P13 based on the image capturing conditions for the background image P11 (step S84). More specifically, the image synthesis unit 8g rotates the subject image P13 through a required angle such that the horizontal direction of the image P13 coincide with that of the image P11.

When the image capturing condition determiner 8f determines that the image capturing conditions for the background image P11 coincide with those for the subject image P13 (YES in step S83), the image synthesis unit 8g performs a processing process of step S84 and subsequent steps on the subject image P13 without rotating the same.

As in the embodiment 1, when a synthesizing position of the subject image P13 in the image P11 is specified in accordance with a predetermined operation on the operator input unit 12 (step S37), the image synthesis unit 8g performs an image synthesizing process which includes synthesis of the background image P11 and the subject image P13 (including an image rotated in step S84) (step S38).

Then, as in the embodiment 1, CPU 13 causes the display control unit 10 to display, on the display 11, a synthesized image P14 (see FIG. 11C) where the subject image P13 is superimposed on the background image P11 based on image data of the synthesized image P14 produced by the image synthesis unit 8g (step S39), and then terminates the synthesized image producing process.

As described above, according to the camera device 200 of the embodiment 2, the image capturing condition acquirer 8e acquires inclinations of the background image P11 and the subject image P13 to the horizontal as the image capturing conditions. Then, the image capturing condition determiner 8f determines whether the inclinations of these images coincide. If it does not, the image synthesis unit 8g performs the predetermined rotating process on the subject image P13 and then synthesizes a resulting image P13′ and the background image P11 inoto a synthesized image P14 (see FIG. 11C).

Thus, a synthesized image P14 giving little sense of discomfort is produced.

As described above, when in the embodiment 2 the image capturing condition determiner 8f determines that the image capturing conditions (inclination information) for the background image P11 do not coincide with those for the subject image P13, the image synthesis unit 8g is illustrated as rotating the image P13 through the required angle such that its horizontal direction coincides with that of the background image P11, the present invention is not limited to this particular case. For example, the background image P11 may be rotated through the required angle such that the horizontal direction of the background image P11 coincides with that of the subject image P13.

However, the rotation of the background image P11 would incline its whole image with respect to the display screen, thereby, for example, displaying inclined configurations of the image P11, which makes its looks poor. Thus, in this case, the image synthesis unit 8g preferably performs a trimming process such that the length and breadth of an area image containing the subject image coincide substantially with the vertical and horizontal, respectively, or otherwise the image is preferably displayed enlarged such that no configurations of the image inclined when the image has been displayed appear on the display 11.

Alternatively, the arrangement may be such that after both the subject image P13 and the background image P11 are rotated a predetermined angle at a time such that the inclination of the picture P13 coincides with that of the picture P11, the image synthesis unit 8g synthesizes these images or take account of the inclinations of these pictures to the vertical as well as to the horizontal.

The present invention is not limited to the embodiments 1 and 2 and various improvements and design changes may be performed without departing from the spirit of the present invention. For example, although in the embodiments 1 and 2 it is illustrated that the image synthesis unit 8g synthesizes the background image P1 and the subject image P3 based on the image capturing conditions including the brightness, contrast, and color tone of the background image P1 (P11) and the subject image P3 (P13) as well as their inclinations to the horizontal, the standards for the image synthesis are not limited to the illustrated ones.

More particularly, the arrangement may be such that the image capturing condition acquirer 8e acquires information on the brightness of the synthesizing position of the subject image P3 on the background image P1, and then that the image synthesis unit 8g adjusts the brightness of the image P3 based on the acquired information on that brightness, and then produces a synthesized image P24 of a resulting adjusted version of the image P3 and the background image P1.

More specifically, the arrangement may be such that the image capturing condition acquirer 8e measures the brightness of each pixel of the background image P1 based on its image data and then detect the whole brightness of the background image P1; that the image capturing condition acquirer 8e then acquires information on the brightness of the synthesizing position of the subject image P3 on the picture P1 and information on the relative brightness of the synthesizing position to the whole background image P1; and then that the image synthesis unit 8g adjusts the brightness of the subject image P3 to the brightness of the synthesizing position and the relative brightness and then synthesizes a resulting adjusted version of the subject image P3 and the background image P1. Thus, a synthesized image P4 giving little sense of discomfort is produced.

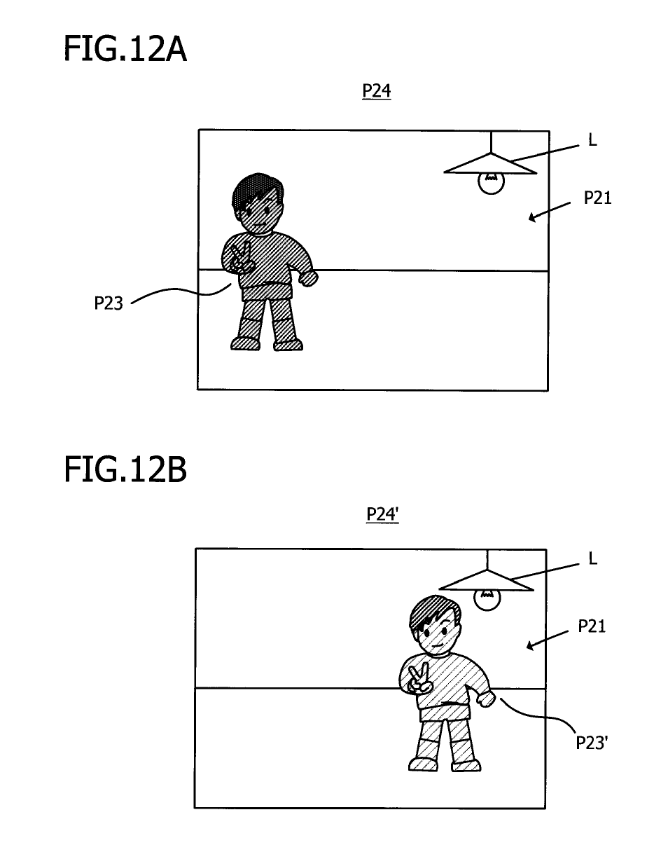

The arrangement may be such that the image capturing condition acquirer 8e detects an image of a light source L (such as, for example, a fluorescent or incandescent lamp) from the background image P21 based on the brightness of each of the pixels of the image P21, and then that the image synthesis unit 8g adjusts the brightness of the subject image P23 depending on a distance between the position of the light source L image and the synthesizing position of the subject image P23. These images are shown in images P24 and P24′ of FIGS. 12A and 12B, respectively.

Alternatively, the arrangement may be such that, for example, when synthesizing the subject image P23 at a position distant from the light source L image on the background image P21, the image synthesis unit 8g performs an image processing process so as to darken the subject image P23 (see the image P24 of FIG. 12A).

On the other hand, when synthesizing the subject image P23 at a position on the background image P21 nearer the light source L image, the image synthesis unit 8g performs an image processing process so as to lighten the subject image more than the subject image P23′ (see the image P24′ of FIG. 12B). It is meant that in FIGS. 12A and 12B the brightness of the subject image increases as the number of parallel diagonal lines drawn thereon decreases; i.e., that the image P23′ is brighter than the image P23.

That is, the image synthesis unit 8g may synthesize the subject image P23 and the background image P21 only based on the position information on the light source L image acquired by the image condition acquirer 8e.

At this time, the image synthesis unit 8g may give a shade to the subject image P23 and then performs the image synthesis based on information on the synthesizing position of the subject image P23 and on the position of the image of the light source L and then performs the image synthesis. For example, the image synthesis unit 8g may change the direction of the shade applied to the subject image P23 depending on the position of the image of the light source L and then synthesizes a resulting shaded version of the image P23 and the background image P1. Further, the image synthesis unit 8g may increase the density of the shade as the distance between the synthesizing position of the subject image P23 and the position of the image of the light source L decreases.

As described above, the image synthesis unit 8g gives a shade to the subject image P23 based on the position information on the image of the light source L in the background image P21 acquired by the image capturing condition acquirer 8e and the position information on the synthesizing position of the subject image P23 in the background image P21 and then synthesizes a resulting shaded version of the subject image and the background image P21. At this time, the image synthesis unit 8g can take account of an incident or incoming direction of light from the image of the light source L to the subject image P23. Thus, a synthesized image P24 giving little sense of a discomfort is produced.

When an image of the sun is detected as the image of the light source from the background image P1, the image synthesis unit 8g need not adjust the brightness of the subject image P23 depending on the distance between the position of the light source image and the synthesizing position of the subject image P23 in the background image P1. Thus, the subject image P23 may be preferably given a shade and then synthesized with the background image P1.

When a motion JPEG image is synthesized as a subject image P23 which moves in the background image, and the position of the subject image P23 relative to the image of the light source L and the brightness of the synthesizing position change, the image capturing condition acquirer 8e acquires information on the position of the subject image 23 relative to the image of the light source L and on the brightness of the synthesizing position of the subject image P23 for each image frame. Then, the image synthesis unit 8g changes the brightness of the subject image 23 and gives a shade in a predetermined direction to the subject image, based on that position and brightness, and then synthesizes a resulting processed version of the subject image and the background image.

Further, while in the embodiments 1 and 2 the image synthesis unit 8g is illustrated as synthesizing the background image P1 (P11) and the single subject image P3 (P13), the number of subject images to be synthesized with the background image P1 (P11) may be more than one. In this case, a required image processing process or a required image rotating process is preferably performed such that all the subject images P3 and the background image P1 give no sense of discomfort.

While in the above embodiments the subject image cutout process is illustrated as being performed after the background image producing process is performed, the order of performing these processes may be reversed.

Alternatively, the arrangement may be such that after the user specifies the image synthesis mode, the electronic image capture unit 2 captures a desired background image and a desired subject image and that the image synthesis unit 8g then synthesizes these background and subject images.

For example, the arrangement may be such that a desired background image is prestored on the recording medium 9 in association with image capturing conditions therefor; that after the user specifies the image synthesis mode, the electronic image capture unit 2 captures a desired subject image to be synthesized with that background image; that the image capturing condition acquirer 8e acquires image capturing conditions including the brightness and contrast of the subject image; and that the image synthesis unit 8g performs an image processing process on those images so that the image capturing conditions for the background image fit those for the subject image.

Similarly, the arrangement may be such that the image capturing condition acquirer 8e acquires information on the brightness of a synthesized area of the subject image in the background image; that after the user specifies the image synthesis mode, the electronic image capture unit 2 captures a desired subject image to be synthesized with the background image; and that the image synthesis unit 8g acquires information on the brightness of the subject image and performs an image processing process so that both the brightnesses of the subject image and the background image become equal.

Also, similarly, the arrangement may be such that the position of the image of the light source in the background image is specified; that after the user specifies the image synthesis mode, the electronic image capture unit 2 captures a desired subject image to be synthesized with the background image; that the image synthesis unit 8g performs a required image processing process on the subject image based on the position of the light source image in the background image and the position where the subject image is synthesized with the background image.

The structure of the cameras 100 and 200 illustrated as the image processor in the embodiments 1 and 2 is as an example and not limited to the illustrated ones. For example, the arrangement may be such that a particular camera device different from the above-mentioned camera devices 100 and 200 produces a background image and a subject image and that the image processor records only the image data and image capturing conditions received from the particular camera device and performs the synthesized image producing process.

In addition, although in the above embodiments the image capturing condition acquirer 8e and image synthesis unit 8g of the image processing subunit 8 are illustrated as driven under control of CPU 13 to realize the present invention, CPU 13 may instead execute a predetermined program to implement the present invention.

To this end, a program memory (not shown) should includes a program comprising a command processing routine, an image processing routine and an image synthesizing routine; a program comprising an area specifying routine, a brightness acquiring routine and an image synthesizing routine; or a program comprising a specified processing routine, a position specifying routine and an image synthesizing routine.

The command processing routine may command CPU 13 to synthesize a plurality of images stored on the recording medium 9. The image processing routine may cause CPU 13 to read, from the recording medium 9, the image capturing conditions related to the respective images to be synthesized and process the image capturing conditions for one of the images so as to fit those for the other image.

The synthesizing routine may command CPU 13 to synthesize the processed image and the other image.

The area specifying routine may command CPU 13 to specify area(s) in one of at least two images where the other image(s) are synthesized with the one image. The brightness acquiring routine may cause CPU 13 to acquire brightness(es) of the area(s) in the specified one image. The synthesizing routine may cause CPU 13 to process the other image(s) such that their brightnesses fit the acquired brightness of the area(s) in the one image, and then synthesize a resulting processed version(s) of the other image(s) and the one image.

The specified processing routine may cause CPU 13 to specify the position of a light source image in one of at least two images. The position specifying routine may cause CPU 13 to specify a position(s) in one image with which the other image(s) are synthesized. The synthesizing routine may cause CPU 13 to process the other image(s) based on the specified synthesizing position(s) and the position of the light source image in the one image and then synthesize a resulting processed version(s) of the other image(s) and the one image.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. An image processor comprising:
a storage unit configured to store a plurality of images each associated with a respective one of a like number of sets of image capturing conditions set when the plurality of images are captured;
a command issuing unit configured to issue a command to synthesize two of the plurality of images stored in the storage unit;
an image processing subunit configured to read, from the storage unit, two sets of image capturing conditions each associated with a respective one of the two images the command for synthesis of which is issued by the command issuing unit and to process one of the two images so as to fit the other image in image capturing conditions; and
an image synthesis unit configured to synthesize a resulting processed version of the one image with the other image.

2. The image processor of claim 1, further comprising:
an image capturing condition determiner configured to determine whether the set of image capturing conditions associated with one of the two images the command for synthesis of which is issued by the command issuing unit coincide substantially with the set of image capturing conditions associated with the other image; and wherein:
the image processing subunit is responsive to determining that the set of image capturing conditions associated with the one of the two images the command for synthesis of which is issued by the command issuing unit do not coincide substantially with the set of image capturing conditions associated with the other image to process the other image such that the set of image capturing conditions for the other image fit the set of image capturing conditions for the one image.

3. The image processor of claim 1, wherein:
each set of image capturing conditions comprises at least one of contrast and color tone set when each image is captured.

4. The image processor of claim 1, wherein;
the set of image capturing conditions associated with each image comprise an inclination of that image to the horizontal when this image is captured; and
the image processing subunit reads information on the inclinations of the two images to the horizontal from the storage unit and changes the inclination of one of the two images to the horizontal so as to fit that of the other image.

5. The image processor of claim 1, further comprising:
an image capturing unit;
an image capturing condition acquirer configured to acquire a set of image capturing conditions for an image when same is captured; and
a storage control unit configured to control the storage unit such that the storage unit stores an image captured by the image capturing unit in association with the set of image capturing conditions captured by the image capturing condition acquirer.

6. An image processor comprising:
an area specifying unit configured to specify an area(s) in one of at least two images where the remaining one(s) of the at least two images are synthesized with the one image;
an brightness acquiring unit configured to acquire brightness(es) of the area(s) in the one image specified by the specifying unit where the one image is synthesized with the remaining one(s) of the at least two images; and
a synthesis unit configured to process the remaining one(s) of the other images such that the brightness(es) of the remaining one(s) of the other images fit that (or those) of the area(s) of the one image acquired by the brightness acquiring unit and then to synthesize a resulting processed version(s) of the remaining one(s) of the at least two images with the one image.

7. An image processor comprising:
a position specifying unit configured to specify the position of a light source image in one of at least two images; and
a position indicating unit configured to indicate a position in the one image where the remaining one(s) of the at least two images are synthesized; and
a synthesis unit configured to process a predetermined process on the remaining one(s) of the at least two images based on the position of the light source image in the one image and the position(s) in the one image indicated by the position indicating unit, and to synthesize a resulting processed version(s) of the remaining one(s) of the at least two images with the one image.

8. The image processor of claim 7, wherein:
the processing of the synthesis unit comprises at least one of a process for adjusting the brightness of the remaining one(s) of the at least two images and a process for giving a shade to the remaining one(s) of the at least two images.

9. The image processor of claim 10, wherein:
the remaining one(s) of the at least two images are a subject image cut out from an image of a subject and a background.

10. A software program product embodied in a computer readable medium for causing a computer for an image processor, which computer comprises a storage unit for storing a plurality of images each associated with a respective one of a like number of sets of image capturing conditions set when the plurality of images are captured, to function as:
a command data issuing unit configured to issue a command to synthesize two of the plurality of images stored in the storage unit;
an image processing subunit configured to read, from the storage unit, two sets of image capturing conditions each associated with a respective one of the two images the command for synthesis of which is issued by the issuing unit and to process one of the two images so as to fit the other image in image capturing conditions; and
an image synthesis unit configured to synthesize a resulting processed version of the other image with the one image.

11. A software program product embodied in a computer readable medium for causing a computer for an image processor to function as:
an area specifying unit configured to specify an area(s) in one of at least two images where the remaining one(s) of the at least two images are synthesized with the one image;
a brightness acquiring unit configured to acquire brightness(es) of the area(s) in the one image specified by the specifying means where the one image is synthesized with the remaining one(s) of the at least two images; and
a synthesis unit configured to process the remaining one(s) of the other images such that the brightness(es) of the remaining one(s) of the other images fit that (or those) of the area(s) of the one image acquired by the brightness acquiring means and to synthesize resulting processed version(s) of the remaining one(s) of the at least two images with the one image.

12. A software program product embodied in a computer readable medium for causing a computer for an image processor to function as:
a position specifying unit configured to specify the position of a light source image in one of at least two images; and
a position indicating unit configured to indicate a position(s) in the one image where the remaining one(s) of the at least two images are synthesized; and
a synthesis unit configured to process the remaining one(s) of the at least two images based on the position of the light source image in the one image and the position(s) in the one image indicated by the position indicating unit, and to synthesize a resulting processed version(s) of the remaining one(s) of the at least two images with the one image.
